(19) United States
(12) Patent Application Publication
(10) Pub. No.: US 2002/0122012 A1
(43) Pub. Date: Sep. 5, 2002

(54) Visual display arrangement and method for ascertaining the local position of a visual display unit within a visual display arrangement having a multiplicity of visual display units

(76) Inventors: Franz Hofmann, Munchen (DE); Stefan Jung, Munchen (DE)

Correspondence Address: Craig Gregersen, Briggs and Morgan, P.A., W2200 First National Bank Building, St. Paul, MN, 55101, US

(21) Appl. No.: 09/933,933

(22) Filed: Aug. 20, 2001

(30) Foreign Application Priority Data
Aug. 23, 2000 (DE) 10041436.2

(51) Int. Cl. G09G 5/00

(52) U.S. Cl. 345/1.1

(57) ABSTRACT

Visual display arrangement and method for ascertaining the local position of a visual display unit within a visual display arrangement having a multiplicity of visual display units.

A visual display arrangement has a multiplicity of visual display units which have a respective control unit associated with them to control them. In addition, a position-finding unit coupled to the visual display units and/or to the control units is provided which can be used to ascertain the local position of the visual display units within the visual display arrangement.

The invention relates to a visual display arrangement and to a method for ascertaining the local position of a visual display unit within a visual display arrangement having a multiplicity of visual display units.

Various visual display units, for example a liquid crystal display unit and a thin-film transistor display unit (TFT display unit), are known from [1].

In addition, “electronic-paper” display units, i.e. electrophoretic display units, are known from [2], [3], [4], [5], [6], [7] and [8].

The known visual display units are suitable for a large-area visual display arrangement only to a limited degree. The known visual display units normally have a maximum screen diagonal of approximately 25 inches.

If a display is meant to have a much larger screen diagonal, then, for a very high spatial resolution of the individual pixels in the visual display unit, technological control of a very high density of pixels using conductor tracks of appropriate length would be necessary to control the individual pixels in the visual display unit, which reduces the efficiency which can be achieved for the respective visual display unit.

Even if such technology could be controlled, such a visual display unit would be of very complex design and would thus be very costly to manufacture.

[9] describes a visual display arrangement having a multiplicity of visual display units in which the local position of the individual visual display units within the visual display arrangement is already known in advance. Received data to be displayed on the visual display units are selected and are transmitted to the appropriate visual display unit for display on the basis of the co-ordinates already known in advance, i.e. on the basis of the local positions.

[10] describes a visual display arrangement having a multiplicity of visual display units in which a data stream for respective data to be displayed actually contains information regarding which of the visual display units is to have the respective information displayed on it.

[11] describes a method for navigating in an interactive system. In this method, at least one element linked to a node of a presentation area in the interactive system is displayed On the basis of a selection signal used to identify a selected presentation area, a second node is determined and at least one element linked to the second node is displayed.

[12] describes a visual multiple display having at least one screen. The multiple display comprises a supporting column and a display head arranged on the column.

The display head has a plurality of screens distributed around the circumference for displaying pictures. The display head can be raised and lowered.

The invention is thus based on the problem of specifying a visual display arrangement having a very large picture format which is inexpensive and simple to manufacture.

The invention is also based on the problem of easily ascertaining, for a multiplicity of visual display units coupled to one another, the local position of a visual display unit within the visual display arrangement.

The problems are solved by the visual display arrangement, and by the method for ascertaining the local position of a visual display unit within a visual display arrangement having a multiplicity of visual display units, having the features in accordance with the independent patent claims.

A visual display arrangement has a multiplicity of visual display units, at least some of the visual display units having a control unit for controlling the respective visual display unit which is associated with it and is coupled to it. In addition, a position-finding unit coupled to the visual display units and/or to the control units is provided which can be used to ascertain the local position of the visual display units within the visual display arrangement. The visual display arrangement also has a memory which stores the ascertained local positions of the visual display units.

Within the context of the invention, a visual display unit may be, by way of example, a liquid crystal display unit, a thin-film transistor display unit (TFT display unit), a plasma display unit or else a visual display element called an electronic-paper display unit, i.e. an electrophoretic display unit as described in [2], [3], [4], [5], [6], [7] or [8], for example.

Clearly, the invention can be seen in that a visual display unit having a very large format can be subdivided into a multiplicity of small and hence more cost-effective and simpler visual display units which are coupled to one another in terms of operation and can be controlled on the basis of the video sequences to be displayed on the visual display units.

To make this possible, a position-finding unit is provided which can ascertain the position of the visual display unit within the respective visual display arrangement, which allows the appropriate visual display units within the visual display arrangement to be controlled selectively in order to display the overall picture appropriately on the visual display units.

The visual display arrangement is also simplified and rendered more cost-effective by virtue of a control unit being provided for a respective visual display unit and being uniquely associated with the respective visual display unit.

The respective control unit can have a memory which stores a unique identifier, for example an individual bit sequence.

By way of example, the memory can be an EEPROM, an OTP element (One Time Programmable Element) or a ROM.

The control unit can respectively be in the form of a computer chip which is coupled to the respective visual display unit and can also be arranged therein.

In accordance with one refinement of the invention, the control units and/or the visual display units can be connected in series, with the visual display units and/or the control units being arranged, or connected in series, in matrix form, row by row or column by column.

Arranging the elements row by row or column by column results in a very regular and hence cost-effective visual display arrangement.

To couple the individual control units to one another in each case, lines, preferably two lines, can be provided, so that the coupling is formed using a two-wire line, for example.

This allows a simple arrangement, which can, in principle, be extended on any desired modular basis, of inherently simple and hence cost-effective visual display units to form a large-area visual display arrangement for which, in accordance with one refinement of the invention, it is not even necessary to know the local position within the visual display area arrangement at which the appropriate visual display unit is arranged or is intended to be arranged before the individual visual display units and the corresponding control units are connected together.

This achieves considerable simplification and, associated with this, a considerable cost saving, particularly if the visual display arrangement is frequently disassembled and reassembled.

In accordance with another refinement of the invention, a respective control unit is coupled to the control unit which is directly locally adjacent to it.

Each control unit can have a switch which is arranged in the visual display arrangement such that, in a first switch position of the switch, the respective control unit can be coupled to a locally adjacent control unit, and in a second switch position, the respective control unit can be not coupled to the adjacent control unit.

The lines can be coupled to one another via a local area network, i.e. a LAN.

The position-finding unit can be coupled to the visual display units by means of a radio link.

In accordance with another refinement of the invention, two radio signal transmission/reception units for transmitting and receiving radio signals are provided, so that the radio signals can be exchanged between the position-finding unit and at least one visual display unit or a control unit.

This makes possible a very simple visual display arrangement having three-dimensionally distributed components, which, particularly when electronic-paper visual display units are used on large advertising displays, for example an advertising column, allows the control or display of information, for example video signals, to be transmitted to the respective visual display units on the advertising display using a portable transmitter, for example on or in a vehicle driving past the advertising column.

A method for ascertaining the local position of a visual display unit within a visual display arrangement having a multiplicity of visual display units, having control units for controlling the visual display units, where the visual display units are coupled to one another in series, where a switch is provided for each visual display unit and can be used to couple the visual display units to one another in a first switch position and not to couple the visual display units to one another in a second switch position, and where each visual display unit has an associated unique identifier, has the following steps:

a position-finding unit ascertains the identifiers uniquely associated with the visual display unit,

where the switches in the visual display arrangement are switched to the first switch position during ascertainment,

so that all the visual display units in the visual display arrangement can be addressed upon ascertainment,

so that all the identifiers of the visual display units contained in the visual display arrangement can be ascertained by the position-finding unit.

For each visual display unit contained in the visual display arrangement, the respective switch of the selected visual display unit is switched to the second switch position and those visual display units which can still be controlled in the respective series circuit when the switch has been switched to the second switch position are ascertained.

The statement indicating the visual display units which can still be controlled is stored in a memory of the position-finding unit.

Clearly, the position-finding unit thus becomes able to ascertain in each case the visual display units which are respectively still contained in the series circuit.

In accordance with one refinement of the invention, the respective identifiers are stored in the memory of the position-finding unit with the respective statement indicating which switch unit of which visual display unit has been put into the second switch position.

If the information indicated above is implemented for each visual display unit, i.e. for each switch in the visual display arrangement, it is now a simple matter to determine the local position of each visual display unit within the visual display arrangement from the stored information, since, accordingly for the visual display unit connected to an input of the visual display arrangement, only the actual visual display unit whose switch has been switched to the second switch position can be controlled.

The visual display unit coupled directly thereto is the one in whose second switch position only the first visual display unit and the selected visual display unit itself can be controlled.

The local positions of the other visual display units are ascertained in a corresponding manner.

The method described above is carried out by the position-finding unit set up as appropriate.

The method described above is distinguished by its simplicity and universal applicability, which makes it possible to reconnect the individual visual display units to one another repeatedly in any desired arrangement.

The developments described above for the visual display arrangement apply correspondingly to the method described above.

Exemplary embodiments of the invention are explained in more detail below and are shown in the figures, in which:

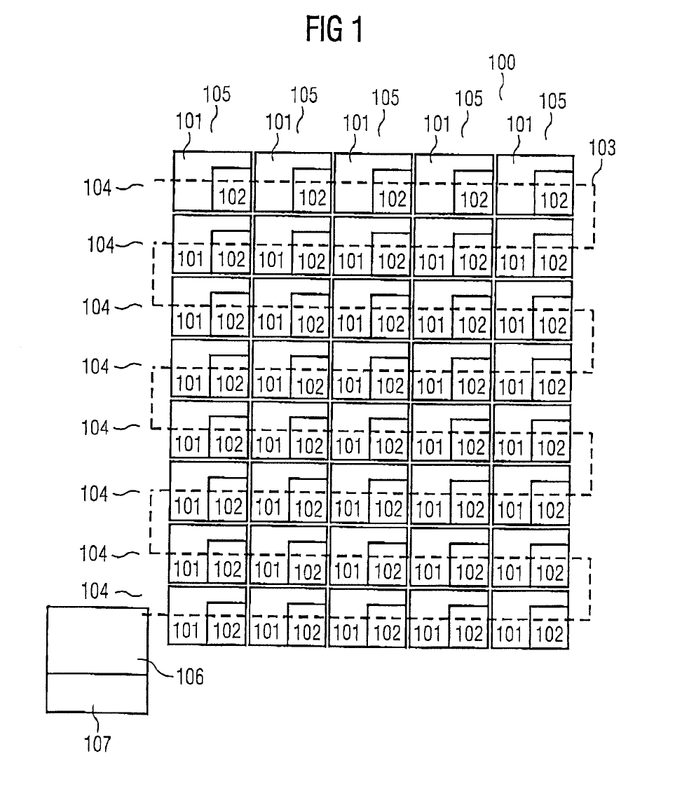

FIG. 1 shows a visual display arrangement having a multiplicity of visual display units in accordance with a first exemplary embodiment of the invention;

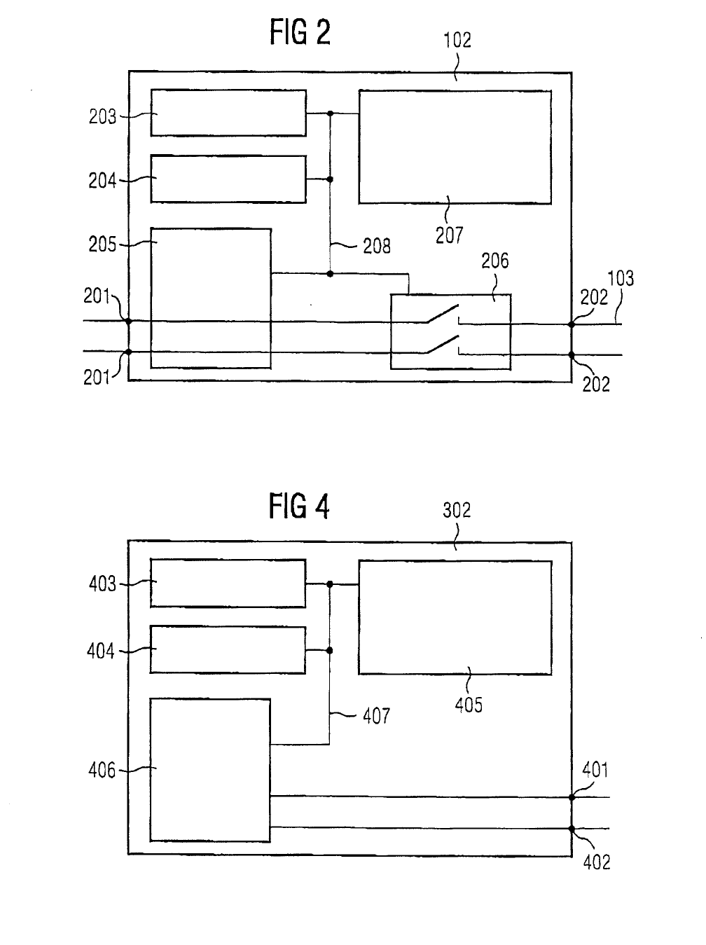

FIG. 2 shows a visual display control unit for a visual display arrangement in accordance with the first exemplary embodiment of the invention;

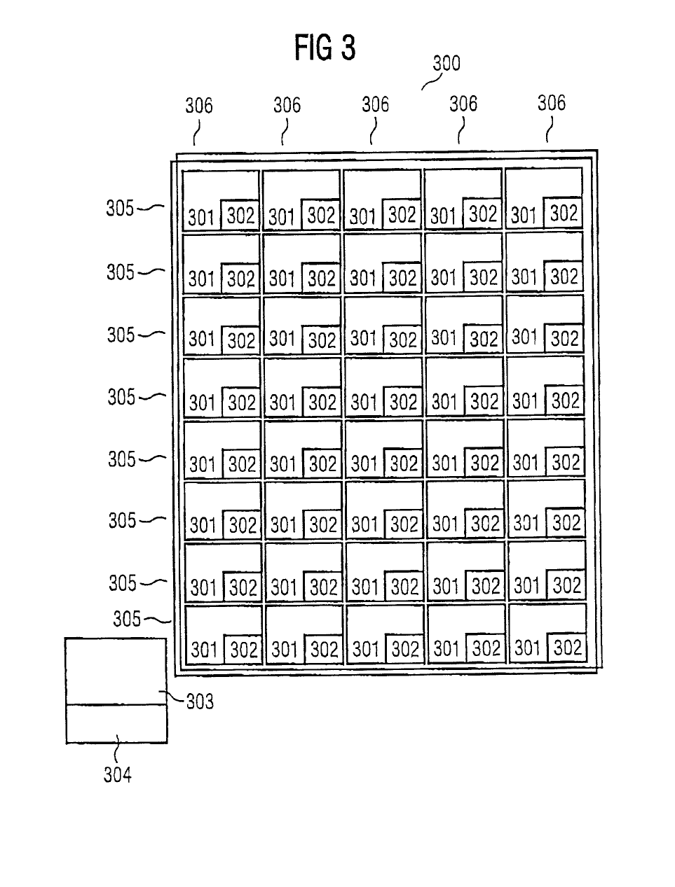

FIG. 3 shows a visual display arrangement having a multiplicity of visual display units in accordance with a second exemplary embodiment of the invention;

FIG. 4 shows a visual display control unit for the visual display arrangement in accordance with the second exemplary embodiment of the invention;

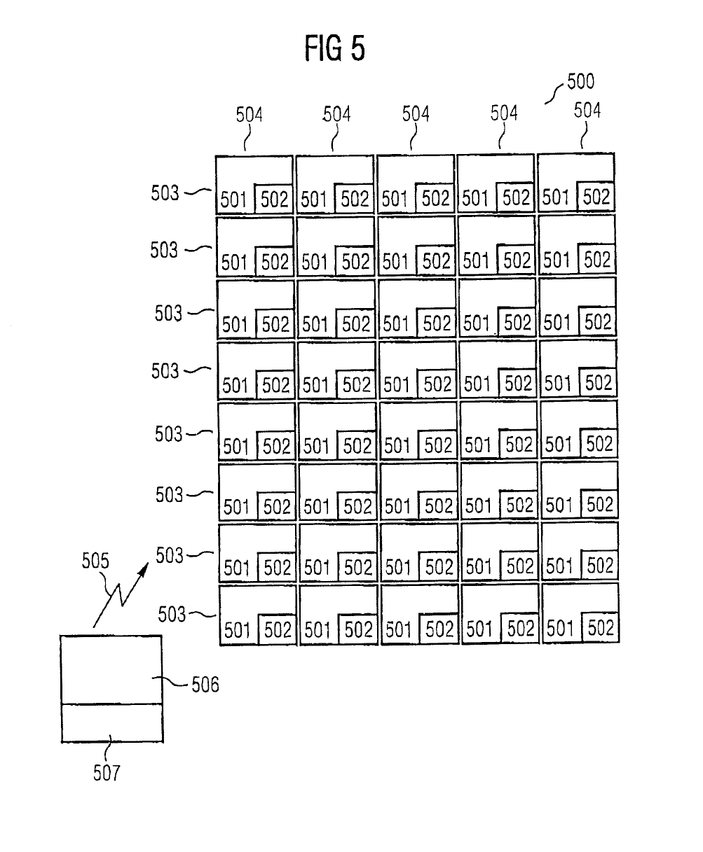

FIG. 5 shows a visual display arrangement having a multiplicity of visual display units in accordance with a third exemplary embodiment of the invention;

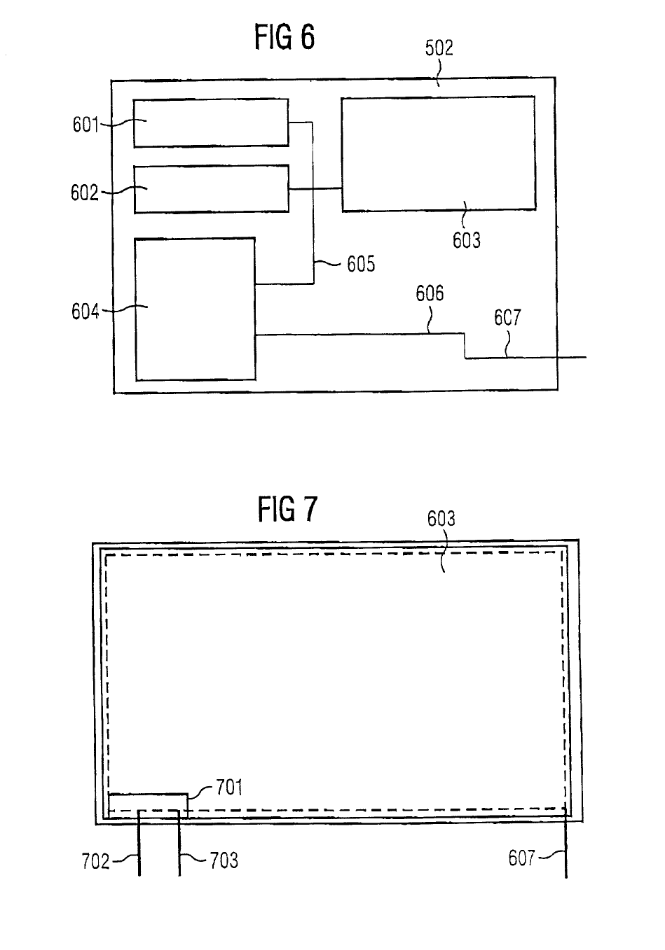

FIG. 6 shows a visual display control unit for the visual display arrangement in accordance with the third exemplary embodiment of the invention;

FIG. 7 shows a visual display controller for the visual display unit in accordance with the third exemplary embodiment of the invention;

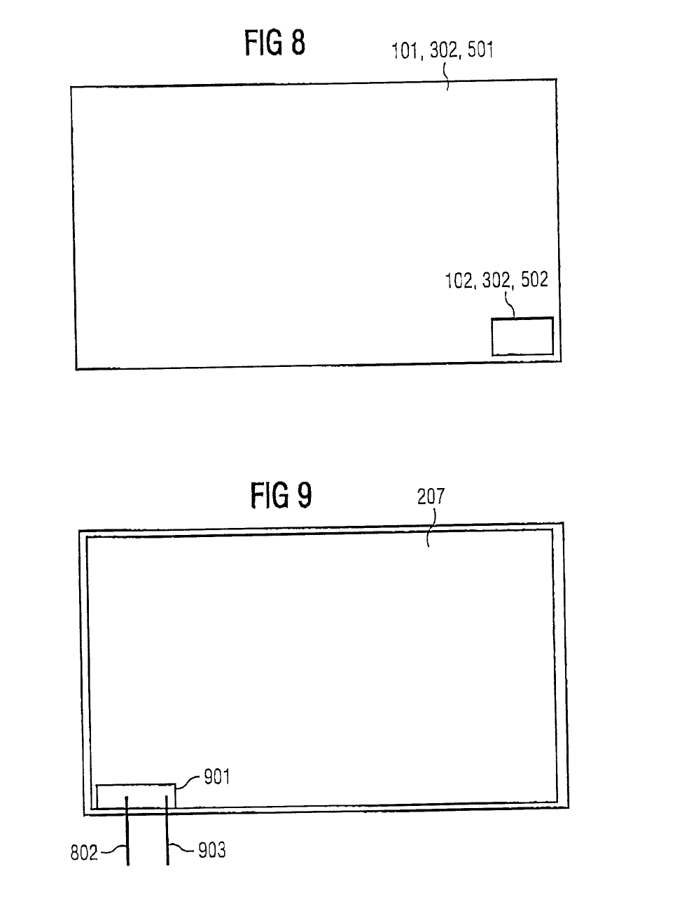

FIG. 8 shows another alternative visual display control unit which can be used in all the visual display arrangements;

FIG. 9 shows a visual display control unit which can be used in a visual display arrangement in accordance with the first exemplary embodiment or in accordance with the second exemplary embodiment.

### First Exemplary Embodiment

FIG. 1 shows a visual display arrangement 100 in accordance with a first exemplary embodiment of the invention.

The visual display arrangement 100 has a multiplicity of visual display units 101.

In accordance with this exemplary embodiment, the visual display unit 101 is a thin-film transistor display unit but may alternatively be in the form of

an electronic-paper display unit, i.e. in the form of an electrophoretic display unit,

a liquid crystal display unit, or

any desired customary screen.

Each visual display unit 101 has a visual display control unit 102 which is uniquely associated with it and, in accordance with this exemplary embodiment, is arranged underneath the thin-film transistor chip such that it can control the respective visual display unit to display video information (cf. FIG. 2).

The individual visual display units 101 are arranged in matrix form in rows 104 and columns 105.

In addition, the visual display units 101 are connected to one another in series, i.e. are linked to one another in series, by means of two-wire lines 103, with the two-wire lines 103 being contained in a respective visual display control unit 102. The two-wire lines 103 pass through each visual display control unit 102 from a respective input 201 to an output 202 of the respective visual display control unit 102.

In addition, the visual display arrangement 100 contains a position-finding unit 106 which is coupled to a connection visual display unit 101 at the start or end of the series circuit comprising the visual display units 101.

In addition, there is a power supply unit 107 both with the position-finding unit 106 and with the individual visual display units 101 in order to operate them.

In accordance with the first exemplary embodiment, the two-wire lines 103 are used both for the supply of power by the power supply unit 107 and for transmitting the respective information to be displayed.

In accordance with another method explained in detail, the position-finding unit 106 ascertains the respective local position of a visual display unit 101 within the visual display arrangement 100, and the local positions of the individual visual display units 101 are sent to the individual visual display units 101 on the basis of the information to be displayed which is recorded by the position-finding unit 106, with the appropriate visual display units 101 displaying the relevant information which is to be displayed.

The design of a visual display control unit 102 in accordance with the first exemplary embodiment is shown in FIG. 2.

A bit sequence uniquely denoting the respective visual display unit 101 is stored as an identifier in a memory 203 of the visual display control unit 102.

In addition, a decoder 204 is provided in the visual display control unit 102 in order to decode the information to be displayed which is supplied to the respective visual display unit 101 by the position-finding unit 106.

For communicating with the position-finding unit 106, the respective visual display control unit 102 also contains a communication unit 205 which is used for communicating, i.e. for transmitting the information to be displayed from the position-finding unit 106 to the respective visual display unit 101, on the basis of a prescribed communication protocol in a local area network (LAN).

In addition, the two lines, i.e. the two-wire line 103, have a switch 206 coupled to them such that, when the switch 206 is off, no signals can be transmitted from the input 201 of the visual display control unit 102 to the output 202 of the visual display control unit 102, which is possible when the switch 206 is on, however.

In addition, the visual display control unit 102 contains a visual display unit control unit 207 for controlling the individual visual display units 101 in order to display the information to be displayed actually on the respective visual display unit 101.

The communication unit 205, the decoder 204, the memory 203 and the visual display unit control unit 207 are coupled to one another by means of a computer bus 208.

The design of the visual display unit control unit 207 is shown in FIG. 9, the respective visual display unit control unit 207 containing a decoder 901 for decoding the video information to be displayed by the visual display unit 101.

In accordance with this exemplary embodiment, after the individual visual display units 101 have been connected to one another and to the position-finding unit 106, the respective local position of the visual display units 101 within the visual display arrangement 100 is still unknown.

To allow the individual display units 101 to be controlled on an individual basis, it is necessary to determine the (relative) local position of the respective visual display unit 101 within the visual display arrangement 100.

In accordance with this exemplary embodiment, the position is determined in the manner below.

In a first step, all the switches 206 of the visual display control units 102 are turned on, so that the position-finding unit 106 can ascertain the identifiers of the respective visual display units 101, which identifiers are stored in the memory 203 thereof and are still unknown to the position-finding unit 106 up to that point.

The appropriate bit sequences are ascertained using the communication unit 201, using a communication protocol which can be prescribed as desired. Since the switches 206 of all the visual display control units 102 are on, the position-finding unit 106 can thus ascertain the identifier of each control unit 102.

The ascertained bit sequences are stored as an identifier for the respective visual display control unit 102 in a memory (not shown) of the position-finding unit 106.

Again using the communication protocol, the following method is carried out for each of the stored identifiers, i.e. for all of the visual display units 101 “registered” with the position-finding unit 106:

The position-finding unit 106 selects a respective visual display unit 101 and controls it such that the switch 206 of the visual display control unit 102 of the selected visual display unit 101 is turned off, so that, from the point of view of the position-finding unit 106, only all the visual display units 101 which are (still) contained in the series circuit for this switch configuration, i.e. apart from the selected visual display unit 101, can be controlled.

The visual display units 101 connected locally downstream of the selected visual display unit 101 can no longer be controlled by the position-finding unit 106 on account of the series connection between the visual display units 101.

If the respective switch 206 is off, then, in a further step, the identifier is ascertained by each visual display unit 101 which can still be controlled by the position-finding unit 106 on the basis of the current switch configuration.

The set of visual display units 101 which can still be controlled are stored in the memory of the position-finding unit 106 together with the statement relating to the selected visual display unit 101.

After all the visual display units 101 registered and stored in the memory in accordance with the first step have been selected and the method described above has been carried out for them, the memory has n statements stored in it for n visual display units 101 in the visual display arrangement 100, the other visual display units 101 which can still be controlled by the position-finding unit 106 when the switch 206 is off being stored with each statement for each respective visual display unit 101.

Once this information has been ascertained completely, i.e. for all the visual display units 101 contained in the series circuit, it is then possible to ascertain the actual physical arrangement, i.e. the order of the series connection of the individual visual display units 101 within the visual display arrangement 100, since the first visual display unit 101 physically connected directly to the position-finding unit 106 can be identified by virtue of the fact that, when its switch 206 is turned off, no further visual display unit 101 can be controlled.

The visual display unit 101 additionally connected thereto as a second visual display unit 101 is characterized and can be ascertained by virtue of the fact that, when its switch 206 is off, only the first visual display unit 101 can be controlled by the position-finding unit 106.

The other visual display units 101 respectively connected in series can now be ascertained in a corresponding manner.

In another step, the video signals to be displayed call now be sent from the position-finding unit 106 to the respective visual display units 101 on the basis of their local position within the visual display arrangement 100 and can be displayed by said visual display units.

It should be pointed out that the information to be displayed can be compressed in any desired manner and can be transmitted from the position finding unit 106 to the respective visual display unit 106 using any desired communication protocol.

### Second Exemplary Embodiment

FIG. 3 shows a visual display arrangement 300 in accordance with a second exemplary embodiment of the invention.

The visual display arrangement 300 has a multiplicity of visual display units 301 which are likewise connected, i.e. linked, to one another in series.

Each visual display unit 301 again has an associated visual display control unit 302, as is shown for the second exemplary embodiment in FIG. 4 and is explained in more detail below.

The visual display unit 301, which is respectively in the form of thin-film transistor chips, is arranged over the respective visual display control unit 302, which is in the form of a silicon chip.

The visual display control unit 302 is connected by means of two respective lines 401, 402 to two metal planes (not shown) of the chip arrangement, which metal planes are coupled to the power supply 304 and to the position-finding unit 303 for the purposes of power supply and signal transmission, i.e. for the purposes of transmitting the information which is to be displayed.

The visual display units 301 are again arranged in rows 305 and columns 306 in the form of a matrix.

In accordance with the second exemplary embodiment, each visual display control unit 302 likewise has a memory 403 for storing the individual identifier of the visual display unit 301, and also a decoder 404, a visual display unit control unit 405 and a communication unit 406, which units are coupled to one another by means of a bus 407 with the communication unit 306 also being coupled to the two lines 401, 402.

The design of the visual display unit control unit 405 in accordance with the second exemplary embodiment corresponds to that of the visual display unit control unit 207 in accordance with the first exemplary embodiment, as shown in FIG. 9.

Communication takes place, as in accordance with the first exemplary embodiment, using the prescribed communication protocol provided and implemented by the communication unit 406.

In accordance with the second exemplary embodiment, the local position of the individual visual display units 101 within the visual display arrangement 300 is actually stored at the start in the position-finding unit 303, so that the position-finding unit 303 can control the individual visual display units 301 immediately in order to display the video information which is to be displayed.

### Third Exemplary Embodiment

FIG. 5 shows a visual display arrangement 500 in accordance with a third exemplary embodiment of the invention.

The visual display arrangement 500 has a multiplicity of visual display units 501 which are respectively in the form of a thin-film transistor display unit.

Once again, each visual display unit 501 is provided with a visual display control unit 502 for controlling the respective visual display unit 501.

The design of the respective visual display control unit 502 is shown in FIG. 6.

The visual display units 501 are likewise arranged in matrix form in rows 503 and columns 504. The visual display control units 502 are respectively coupled to a position-finding unit 506 by means of a radio link 505, symbolized by an arrow 505 in FIG. 5.

In accordance with this exemplary embodiment, both the position-finding unit 506 and the respective visual display units 506 (not shown) have a power supply 507.

As shown in FIG. 6, each visual display control unit 502 again has a memory 601 for storing the respective unique identifier of the appropriate visual display unit 501 having the associated visual display control unit 502, and also a decoder 602, a visual display unit control unit 603 and a communication unit 604, which are coupled to one another by means of a bus 605.

In addition, the communication unit 604 is coupled by means of a line 606 to an antenna 607 which can be used to set up a communication link as a radio link to the position-finding unit 604.

Hence, both the communication unit 604 and the position-finding unit 506 have a radio signal transmission unit and a radio signal receiver unit to allow communication between these two units.

Again, at the start of display or control of the individual visual display units 501 in order to display video information, the position-finding unit 506 already knows the local position of the respective visual display unit 501 within the visual display arrangement 500.

In accordance with another refinement of the invention, the visual display units 501 are not coupled to at power supply unit, so that, in accordance with this refinement, the information to be displayed is maintained without a power supply.

In accordance with this exemplary embodiment, power is provided wirelessly via the radio link only in order to change the information which is to be displayed.

In accordance with this exemplary embodiment, the visual display unit 501 provided is, in particular, an electronic-paper display unit which is controlled by the position finding unit 506.

In addition, in accordance with another alternative refinement of the third exemplary embodiment, not every visual display control unit 502 has an antenna, but only one visual display control unit 502 has an antenna 609 and the other visual display, control units 502, in the first embodiment are appropriately coupled to the visual display control, unit 502 which has the antenna 607 by means of a two-wire line, so that communication takes place via the visual display control unit 502 having the antenna 607, and the data are transmitted to the other visual display units 501 via the two-wire line.

FIG. 7 shows the visual display unit control unit 603 in accordance with the third exemplary embodiment of the invention, the visual display unit control unit 603 having a decoder 701 which is coupled to the bus 605 by means of lines 702, 703.

FIG. 8 shows a symbolic illustration of the respective visual display unit 101, 301, 501, in accordance with one of the exemplary embodiments illustrated above, having a visual display control unit 102, 302, 502 respectively arranged underneath the visual display unit 101, 301, 501.

The following publications are cited in this document:

[1] S. Sherr, Applications for Electronic Displays—Technologies and Requirements, John Wiley & Sons, 1998

[2] U.S. Pat. No. 5,930,026

[3] U.S. Pat. No. 6,017,584

[4] U.S. Pat. No. 4,126,854

[5] U.S. Pat. No. 5,262,098

[6] U.S. Pat. No. 5,545,291

[7] U.S. Pat. No. 5,824,186

[8] U.S. Pat. No. 5,904,545

[9] U.S. Pat. No. 5,784,035

[10] U.S. Pat. No. 4,800,376

[11] U.S. Pat. No. 5,602,596

[12] DE 196 06 227

1. Visual display arrangement having a multiplicity of visual display units,
in which at least some of the visual display units have a control unit for controlling the respective visual display unit which is associated with it and is coupled to it, and
in which a position-finding unit coupled to the visual display units and/or to the control units is provided which can be used to ascertain the respective local position of the visual display units within the visual display arrangement,
having a memory which stores the ascertained local positions of the visual display units.

2. Visual display arrangement according to claim 1, in which some of the visual display units are in the form of liquid crystal display units.

3. Visual display arrangement according to claim 1 or 2, in which at least some of the visual display units are in the form of TFT display units.

4. Visual display arrangement according to one of claims 1 to 3, in which at least some of the visual display units are in the form of electronic-paper display units.

5. Visual display arrangement according to one of claims 1 to 4, in which at least some of the visual display units are in the form of plasma display units.

6. Visual display arrangement according to one of claims 1 to 5, in which the control unit is a computer chip in each case.

7. Visual display arrangement according to one of claims 1 to 6, in which the control units are connected in series with one another on the basis of a prescribed order.

8. Visual display arrangement according to one of claims 1 to 7, in which a respective control unit is provided for a respective visual display unit and is associated therewith.

9. Visual display arrangement according to one of claims 1 to 8, in which the visual display units are arranged in matrix form in rows and columns.

10. Visual display arrangement according to one of claims 1 to 9, in which the control units are connected in series in matrix form row by row or column by column.

11. Visual display arrangement according to one of claims 1 to 10, in which the control units are coupled to one another by means of two lines.

12. Visual display arrangement according to claim 11, in which the two lines are formed by a two-wire line.

13. Visual display arrangement according claim 11 or 12, in which a control unit is respectively coupled to the control unit which is directly locally adjacent to it.

14. Visual display arrangement according to one of claims 1 to 13, in which each control unit has an associated unique identifier and is stored in a memory of the respective control unit.

15. Visual display arrangement according to one of claims 1 to 14, in which each control unit has a switch which is arranged in the visual display arrangement such that
in a first switch position, the respective control unit is coupled to a locally adjacent control unit,
in a second switch position, the respective control unit is not coupled to an adjacent control unit.

16. Visual display arrangement according to one of claims 12 to 15, in which the lines, are coupled to one another via a local area network.

17. Visual display arrangement according to one of claims 1 to 16, in which the position-finding unit is connected to the visual display units by means of a radio link.

18. Visual display arrangement according to claim 17, having two radio signal transmission/reception units for transmitting and receiving radio signals, the radio signals being exchanged between the position-finding unit and at least one visual display unit or a control unit.

19. Visual display arrangement according to one of claims 1 to 18, in which the visual display units are mounted on an advertising column.

20. Visual display arrangement according to one of claims 14 and 15 to 19, in which the position-finding unit is set up such that the following steps can be carried out to ascertain the local position of a visual display unit within the visual display arrangement:
a position-finding unit ascertains the identifiers uniquely associated with the visual display units, the switches being in the first switch position,
the following method is carried out for each visual display unit contained in the visual display arrangement:
the switch of the selected visual display arrangement is switched to the second switch position,
those visual display units which can still be controlled in the series circuit are ascertained,
the statement indicating the visual display units which can still be controlled is stored,
the local position of a visual display unit within the visual display arrangement is ascertained from the stored statements.

21. Method for ascertaining the local position of a visual display unit within a visual display arrangement having a multiplicity of visual display units, having control units for controlling the visual display unit, where the visual display units are coupled to one another in series, where a switch is provided for each visual display unit and can be used to couple the visual display units to one another in a first switch position and not to couple the visual display units to one another in a second switch position, and where each visual display unit has an associated unique identifier,
in which a position-finding unit ascertains the identifiers uniquely associated with the visual display units, the switches being in the first switch position,
in which the following method is carried out for each visual display unit contained in the visual display arrangement:
the switch of the selected visual display arrangement is switched to the second switch position,
those visual display units which can still be controlled in the series circuit are ascertained,
the statement indicating the visual display units which can still be controlled is stored,
in which the local position of a visual display unit within the visual display arrangement is ascertained from the stored statements.

22. Method according to claim 21, in which the visual display units are controlled to display signals using their ascertained local position.
